(19) United States
(12) Patent Application Publication
(10) Pub. No.: US 2013/0097812 A1
(43) Pub. Date: Apr. 25, 2013

(54) CORD, CABLE AND HOSE FASTENING SYSTEM AND METHOD

(71) Applicant: Stephen William Anthony Sanders, Sebastopol, CA (US)

(72) Inventor: Stephen William Anthony Sanders, Sebastopol, CA (US)

(73) Assignee: Click-a-Cord Inc., Sebastopol, CA (US)

(21) Appl. No.: 13/279,984

(22) Filed: Oct. 24, 2011

(51) Int. Cl. F16G 11/00

(52) U.S. Cl. 24/115 R

(57) ABSTRACT

A system and method for providing cord, cable and hose fastening (CCHF) so Industrial, Commercial and Home users (ICAHUs) can assure that cords, cables and hoses, including but not limited to electrical cords, cannot be accidentally disconnected or unplugged from their supply sources. The system and method allows ICAHUs to work safely and efficiently and to avoid cords, cables and hoses that may accidentally disconnect or unplug themselves from power, fluid or material supplies (PFMS) or fixed connecting boxes or outlets, in the course of everyday use. ICAHUs can easily use PFMS frames or PFMS outlet covers to either capture collar ties, tie connectors or a combination of both that may be used by existing cord, cable and hose fastening systems in order to allow said systems to ensure their respective cords, cables or hoses do not become accidentally disconnected from their appropriate PFMS. Said system applies collar tie stays and/or tie connectors in conjunction PFMS frames or PFMS outlet covers in order to facilitate said present invention.

This application is commonly-owned with U.S. Pat. No. 7,811,117 and U.S. Pat. No. 7,887,360.

### FIELD OF THE INVENTION

The present invention is in the field of Industrial, Commercial and Home use, specifically a system and method to safely fasten a cord, cable or hose, including but not limited to an electrical cord, to a fixed power, fluid or material supply or fixed connecting box. Said cords, cables or hoses may include but shall not be limited to either a stand-alone electrical cord or an electrical cord attached to an electrical device such as a power tool or appliance that one desires to plug into a wall outlet or electrical outlet box. Said invention shall assure that said cords, cables or hoses remain connected to said fixed power, fluid or material supply in the course of normal use and do not become unplugged or disconnected.

### BACKGROUND OF THE INVENTION

Today, it is necessary for Industrial, Commercial and Home users (ICAHUs) of tools and systems, including but not limited to electrical tools, electrical appliances and computer systems to work safely and efficiently. Often, cords, cables or hoses, including electrical cords, may accidentally unplug or disconnect in the course of everyday use; thus, creating an inconvenience and possibly a safety hazard. To avoid said cords, cables and hoses from unplugging or disconnecting from wall outlets and other similar power, material or fluid supply outlets, ICAHUs often try to tape or tie said cords, cables or hoses to fixed objects located near said wall outlets, electrical boxes or said power, material or fluid supplies. This can create a safety hazard and can also unnecessarily consume extra time. Cords, cables and hoses becoming disconnected can be hazardous, and scrambling around to connect cords, cables or hoses that become disconnected can be time consuming. For these reasons and others, this present invention, a cord, cable and hose fastening (CCHF) system and method will easily accommodate and facilitate that said cords, cables and hoses used by ICAHUs stay connected to their respective and appropriately corresponding power, fluid or material supply (PFMS) before, during and after use.

ICAHUs need to work safely and efficiently. For example, an electrical device needs to remain plugged-in to be able to receive electricity to function. Time used to plug-in electrical devices that become unplugged is wasted. ICAHUs also may need to move within a work environment in which cords, cables and hoses may become snagged or caught on objects and could become disconnected from wall outlets and other fixed PFMS. With the CCHF system and method, ICAHUs can easily fasten cords, cables and hoses into PFMS, including but not limited to, cords on electrical devices to assure they remain connected.

In addition, because of the need for ICAHUs to work safely and efficiently, companies such as Home Depot, Ace Hardware, Home Club, Sam's Club, K-Mart, Sears, Stanley, Loews, Wal-Mart and Costco, may more-than-likely desire to sell the cord, cable and hose fastening system and method that is comprised in this invention. This can be sold as a stand alone product or in combination with cords, cables and hoses, including but not limited to electrical cords and power devices, power strips, power extension blocks, and cords attached to power tools.

Heretofore, inventors have not created and developed a system and method for facilitating cord, cable and hose fastening that will fit easily on standard cords, cables and hoses, including but not limited to standard electrical cords, and that will actually hold them securely during the stresses and demands encountered in a work environment to their respective and appropriately corresponding power, fluid or material supply (PFMS) during use. An example would include but not be limited to a standard electrical cord with a male electrical prong being plugged into a standard wall electrical outlet, or an electrical outlet box, and having said cord with male electrical prong being easily fastened to said outlet or outlet box, so as not to become accidentally disconnected while in use. This invention permits said ICAHUs to employ the CCHF system and method easily with many types of cords, cables and hoses, including standard, electrical cords that typically contain male and female connectors or plug ends that fasten by fitting the male connector into the female connector by using direct pressure without the need for any twisting of the connectors or their parts. The present invention will employ the use of either collar tie stays and/or tie connectors to facilitate its desired function.

U.S. Pat. No. 5,348,495 (Kasden, 1994), expressly incorporated herein by reference, relates to an “electrical cord plug lock assembly having a special electrical socket face plate with a pair of laterally spaced locking brackets extending outwardly from its front surface adjacent the opposite sides of the socket aperture. A base clamp member has a locking arm pivotally secured to its respective left and right ends.” (Abstract, lines 1-6). Kasden expressly incorporates “a pair of elongated locking arms each having a front end and a rear end; means for pivotally securing the rear ends of said locking arms to their respective left and right ends of said base clamp member”. (Claim #1, Column 3, lines 33-37). Kasden does not teach the use of either a collar tie stay or a tie connector as is displayed in the present invention. Moreover, the existing art employs a “locking arm” that is fixed, non-flexible and non-adjustable; therefore it would not fit on various sizes and types of cords, cables and hoses and also would not be realistically commercializable. The present invention displays a system and method of employing a collar tie stay to capture a collar tie that is not fixed, is highly flexible and strong, and is easily adjustable in length in the way it interconnects to said tie connector. Moreover, the present invention displays a system and method of employing a tie connector that will connect with corresponding tie connectors employed on other cord, cable and hose fastening systems.

U.S. Pat. No. 5,044,976 (Thomson, 1991), expressly incorporated herein by reference, relates to an “electrical cord holding device and method of using same”. Thompson expressly incorporates “an elongated rigid member which can be attached to the wall outlet between the two dual plug receptacles of the outlet”. (Column 1, lines 33-35). The existing art also incorporates “a second securing means comprising a group of hook members on one of said clamp means and said elongated member and a group of eye members on the other of said clamp means and said elongated member, said hook members and said eye members retentively engaging one another.” (Column 4, Claim #1, lines 21-25.) Moreover, existing art teaches that said hook and eye members “are commonly referred to by the registered trademark “Velcro”. (Column 1, lines 53-54). Thompson does not teach the use of either a collar tie stay or a tie connector as is displayed in the present invention. Moreover, the existing art employs a device and method that may be prone to failure in dirty, dusty conditions and also does not appear to be a robust solution because its weakest link is a Velcro-style fastener which may not provide much holding power. The present invention displays a system and method of employing a collar tie stay to capture a collar tie that is not fixed, is highly flexible and strong, and is easily adjustable in length in the way it interconnects to said tie connector. Moreover, the present invention displays a system and method of employing a tie connector that will connect with corresponding tie connectors employed on other cord, cable and hose fastening systems.

U.S. Pat. No. 5,547,390 (Laherty, 1996), expressly incorporated herein by reference, relates to an “electrical plug securing device” “comprising a strip of material attached to said electrical outlet; at least one appendage integrally attached to said strip; and slots formed in said appendage such that electrical cord, when wrapped around said appendage, may course through said slots in a manner that will inhibit movement of said cord, by friction when tension is applied to said cord”. (Column 4, Claim #1, lines 8-16). Laherty does not teach the use of either a collar tie stay or a tie connector as is displayed in the present invention. Moreover, the existing art employs a device that functions by permitting friction to be applied to said cord which may damage said cord. The present invention displays a system and method of employing a collar tie stay to capture a collar tie that is not fixed, is highly flexible and strong, and is easily adjustable in length in the way it interconnects to said tie connector. Moreover, the present invention displays a system and method of employing a tie connector that will connect with corresponding tie connectors employed on other cord, cable and hose fastening systems.

U.S. Patent Application Publication No. 2004/0166718, (Yoest, Daniel, August 2004), expressly incorporated herein by reference to a “power cord securing device comprising: a clasp member for removably and securably retaining a power cord therein; a securing strap in communication with said clasp member; and, a throughhole formed through said securing strap, said throughhole adapted to receive an electrical outlet cover plate screw for removable attachment of said device to an electrical outlet cover plate, thereby maintaining electrical engagement of electrical conductors of a plug head of the power cord with an electrical outlet.” (Claim #1). Prior art teaches a clasp member that is “substantially U-shaped” (Paragraph 15, lines 3-4) which may fail to hold an electrical cord when it is pulled away from a wall outlet socket. Moreover, existing art claims a “securing strap” which is formed out of one-piece that is also is joined by a “clasp member” on each respective end. Said “securing strap” is not adjustable and is a singular piece which posed two problems: 1) because said “securing strap” is not adjustable it may not fit on a myriad of power cords that employ different types and sizes of male or female plug ends; and 2) because said “securing strap” is a singular piece, it may be prone to failure in that it would be weakest in retaining connected cords when pressure was applied from the direct edge of the “securing strap” that was opposite from the cord, then when applied inward toward said cord. Furthermore, said “securing strap” may have several holes placed in it which may limit its strength. (FIG. 2A). The existing art does not teach the use of either a collar tie stay or a tie connector as is displayed in the present invention. The present invention displays a system and method of employing a collar tie stay to capture a collar tie that is not fixed, is highly flexible and strong, and is easily adjustable in length in the way it interconnects to said tie connector. Moreover, the present invention displays a system and method of employing a tie connector that will connect with corresponding tie connectors employed on other cord, cable and hose fastening systems.

Accordingly, existing inventions describe methods and systems for assuring that electrical cords remain plugged-in or connected, but there does not appear to be an invention that possesses all the features and components of our system and method for delivering a cord, cable and hose fastening solution as in this present invention. To summarize, the systems and methods of the existing inventions have one or more of these disadvantages:
Existing art employs use of locking arms, appendages or securing straps, that are fixed in length and are therefore not adjustable in length, which will not allow them to fit on a vast majority of cords, cables and hoses and their respective sizes and configurations; thereby making said existing art not a realistic device to be mass-manufactured and commercialized.
Existing art employs use of hook and eye style fasteners or straps with wholes placed in them, and thereby, do not provide a solid and robust solution that would function effectively in a rugged environment such as a professional jobsite or outdoors, where dirt, dust, sawdust, mud, rocks and other debris may be present.
Existing art employs the use of “clasps” to attach to a plug that rely on friction; but that ultimately will allow cords to “pop-in” and “pop-out” of said clasp as pressure is applied, thereby failing to secure said cord if it is dragged or pulled during working conditions and an obstacle or if an impediment snags said cord creating pressure on “clasps”.
Existing art employs clasps that are “open” in that they do not surround the cord they attach to but allow the cord an area in which it may “pop-out” of said clasp when under pressure.
Existing art employs a singular securing strap that is not adjustable and therefore will not fit numerous types and sizes for male and female connectors and other connectors as are used on multiple cord configurations.
Existing art employs a singular securing strap that will not allow it to offset pressure paced upon cords when they are under stress during work conditions.
Existing art is not sufficiently strong enough to be used under work conditions, such as at a construction site, where tools are heavy, cords and cables are pulled tight, and fasteners that may fail can create a safety risk.
Existing art does not employ the use of collar tie stays that can capture a flexible collar tie at any number of points thereby making the length of said collar tie fully adjustable.
Existing art does not employ the use of tie connectors and collar ties that allow for adjustability of the length of said collar ties and that also allow said tie connectors to interoperate with said tie connectors of other systems and methods in use that are highly commercializable and will become widely adopted.

### SUMMARY OF THE INVENTION

The present invention relates to a system and method enabling a cord, cable or hose to remain connected to a power, fluid or material supply (PFMS) during use, and not to become accidentally disconnected or unplugged while being used by Industrial, Commercial and Home users (ICAHUs) that may be using cords, cables or hoses, including but not limited to cords on electrical tools and appliances. Said invention allows ICAHUs to work safely and efficiently and without unnecessary interruption. This present invention, a cord, cable and hose fastening (CCHF) system and method will easily accommodate and facilitate that said cords, cables and hoses used by ICAHUs stay connected during use. Moreover, the present invention will also interoperate seamlessly with other patented devices, systems and methods that are expected to become new industry standards and encounter widespread adoption by global users.

This present invention will be described further in preferred embodiments, and it overcomes all of the above-mentioned disadvantages of today's existing art. This invention secures cords, cables and hoses to power, fluid or material supply (PFMS) during use and provides an ideal solution for securely assuring that a cord, cable or hose remains connected. Moreover, this invention also allows for said cord, cable and hose to be secured to items or areas extremely near to said power, fluid or material supply (PFMS) which would facilitate any accidental disconnection of said cord, cable or hose from said PFMS. An example would be an electrical cord attached to a power tool or a device, in which said extension cord would need to be plugged into an electrical outlet, or wall socket or electrical box in order to supply power to said power tool or device.

Broadly stated, this present invention is a cord, cable and hose fastening system and method that is interoperable with existing and patented inventions and devices that connect to cords, cables and hoses by employing the use of collars, collar ties and tie connectors.

This invention consists of either: 1) a frame with tie connectors and/or collar tie stays to fit onto; 2) a cover with tie connectors and/or collar tie stays to fit over or onto; 3) a series of either tie connectors and/or collar tie stays to fit near or onto; a power, fluid or material supply (PFMS) including but not limited to electrical outlets, power strips and boxes. Various cords, cables and hoses receive power, fluid or material from various sources. An electrical outlet for example provides electrical power to an electrical cord to power a hand tool. A hydraulic fluid fitting or outlet for example provides hydraulic fluid typically to a hydraulic line, in which said hydraulic fluid may be required to perform an important or vital function, such as in a hydraulic brake system. Material may be supplied via hoses, in many forms including but not limited to air to power pneumatic tools, liquids, gases, pressurized gases, solids, semi-solids, etc., for various purposes. In summary, the present invention employs a said frame, said cover or said series of either tie connectors and/or collar tie stays to fit near or onto; a PFMS will not become accidentally disconnected from its corresponding cord, cable or hose. Any said frame or said cover will contain collar tie stays, tie connectors or both in combination. Said present invention employs use of either tie connectors, collar tire stays, or both in combination in order to respectively fasten to said PFMS any incoming corresponding tie connectors or collar ties of a cord, cable or hose fastening system in use that is attempting to connect to said PFMS.

Said collar tie stays are designed to hold incoming collar ties from other systems in place, in order to assure a consistent connection between cords, cables hoses and their appropriate PFMS. Said tie connectors are designed to connect easily and strongly to incoming tie connectors from other systems in place, in order to assure a consistent connection between cords, cables hoses and their appropriate PFMS.

The invention further relates to a method of maintaining a connection between cords, cables and hoses and their corresponding PFMS in which collar ties may be used solely or in conjunction with tie connectors, or in which tie connectors can ride on collar ties thereby allowing adjustability between both which will allow for the length of said collar tie to be easily adjustable. Said tie connectors are designed, in some configurations, to be able to fold or swivel in order to save space during shipping and also to become more compact and hidden when not in use. Tie connectors and/or collar tie stays may also be positioned on or near, or molded into several form factors including but not limited to power strips, attachable/detachable frames, covers and outlet covers, electrical plug extension blocks or extenders or multipliers, or other forms.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a drawing depicting a mode of the commonly-owned inventions with which the present invention is interoperable and compatible, of the preferred embodiment.

FIG. 2 is a drawing depicting a mode of the Cord, Cable and Hose (CCHF) Fastening System and Method, including tie connectors, of the preferred embodiment.

FIG. 3 is a drawing depicting a mode of the Cord, Cable and Hose (CCHF) Fastening System and Method, including collar stays, of the preferred embodiment.

FIG. 4 is a drawing depicting a mode of the Cord, Cable and Hose (CCHF) Fastening System and Method, including an electrical outlet cover with embedded collar stays, of the preferred embodiment.

FIG. 5 is a drawing depicting a mode of the Cord, Cable and Hose (CCHF) Fastening System and Method, including a collar tie with a mounting hole, of the preferred embodiment.

FIG. 6 is a drawing depicting a mode of the Cord, Cable and Hose (CCHF) Fastening System and Method, including a collar tie with a mounting hole and mounting means, of the preferred embodiment.

FIG. 7 is a drawing depicting a mode of the Cord, Cable and Hose (CCHF) Fastening System and Method, including an electrical power strip and tie connectors, of the preferred embodiment.

FIG. 8 is a drawing depicting a mode of the Cord, Cable and Hose (CCHF) Fastening System and Method, including collar stays, of the preferred embodiment.

FIG. 9 is a drawing depicting a mode of the Cord, Cable and Hose (CCHF) Fastening System and Method, including tie connectors, of the preferred embodiment.

### DETAILED DESCRIPTION OF THE INVENTION

In greater detail, this present invention, in its preferred form, is a cord, cable and hose securing device having collar tie stays, tie connectors or both in combination that attach to a PFMS frame or cover.

The purpose of the PFMS frame is to attach onto or next to said PFMS and to provide a connection point to said collar tie stays, said tie connectors, or to both in combination. Said PFMS frame may be in various sizes and configurations including but not limited to fitting seamlessly onto numerous electrical boxes and outlets.

The purpose of the PFMS cover is also to attach onto or on top of said PFMS and to provide a connection point to said collar tie stays, said tie connectors, or to both in combination. Said PFMS cover may be in various sizes and configurations including but not limited to fitting seamlessly onto numerous electrical boxes, power strips and outlets.

The purpose of the collar tie stays is to capture incoming collar ties from existing systems in use and to create friction onto said incoming collar tie in order to facilitate that incoming cord, cable or hose remains connected to the desired PFMS. Said collar ties may work solely or in conjunction with tie connectors.

The purpose of the tie connectors is to connect to corresponding and appropriate incoming tie connectors from existing systems in use in order to facilitate that incoming cord, cable or hose remains connected to the desired PFMS. Said tie connectors can also have an adjustability function by allowing a collar tie on present invention to weave inside of said tie connectors. Said tie connectors can also snap or lock onto or swivel on guides that can be attached to said PFMS frame or PFMS cover. Said tie connectors can also be embedded into said PFMS frame or PFMS cover in order to create a low-profile, clean look, desired spacing between parts of present invention or a more aesthetically pleasing appearance. Said tie connectors can also be placed near said PFMS and fastened to various objects using various mounting techniques. Tie connectors may take on various form factors and various positions related to other parts of the invention including but not limited to, to be embedded, recessed, hidden, placed in front, on the side, on side or behind, or near said PFMS. Tie connectors may be or may resemble male and/or female buckles in any form factor. Tie connectors may be used in combination with collar tie stays or said collar tie stays may be used in lieu of any tie connectors.

Numerous tie connectors of various configurations, including but not limited to singular, pairs, multiple or strip mounted, may be used and mounted as necessary in order to facilitate present invention. Any singular, pairs or strip mounting of said tie connectors or said collar tie stays may also be connected to various PFMS frames, cover or other objects near said PFMS. Said tie connectors and/or collar tie stays may be connected to or near said PFMS by several means including but not limited to screw-on, bolt-on, snap-on, use of hook and loop Velcro-style fastener, plastic cord, zip tie, cord, and other mounting options.

A cover may be employed in various form factors to hide or cover tie connectors and/or collar tie stays and to protect them or to provide a more aesthetic product.

Accordingly, a feature and advantage of this present invention is its ability to prevent accidental or forced disconnection of cords, cables and hoses, such as electrical cords.

Another feature and advantage of the present invention relates to the ease of manufacture of the cord, cable and hose fastening device. Because of the design of the device, the production of the device is very simple and inexpensive. Moreover, said present invention is designed to fit on various existing, typical and commonly used PFMS boxes, outlets, fittings and devices. Many competing devices have never been commercialized or accepted because they were not adjustable or usable on the large embedded base of PFMS around the world.

The preferred embodiment of the present invention will now be described in even greater detail by reference to the following figures.

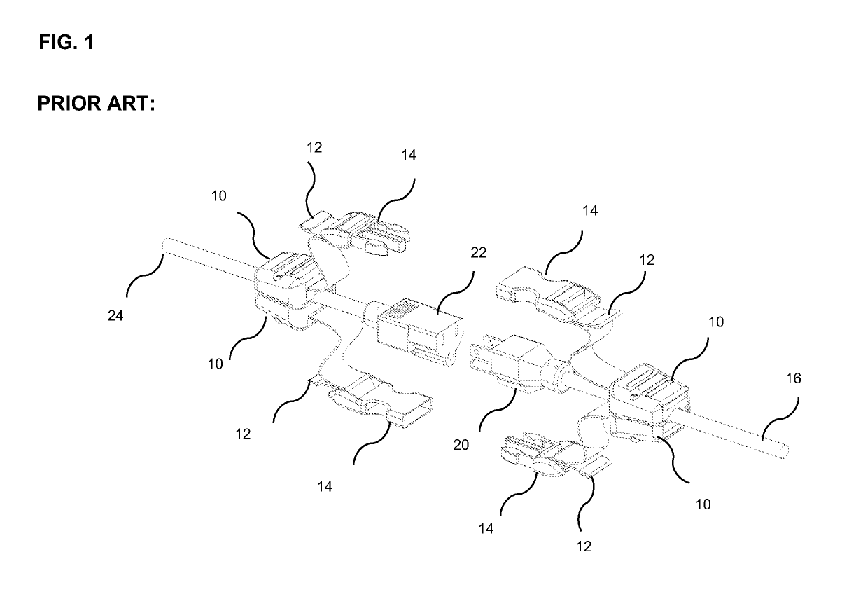

FIG. 1 depicts a drawing depicting a mode of the commonly-owned inventions with which the present invention is interoperable and compatible. In this figure, a series of collars 10 attach to collar ties 12 which attach to tie connectors 14. Said collars 10 secure themselves to an electrical cord with a female end plug 24 and to an electrical cord with a male end plug 16. Said female plug end 22 typically supplies electricity and said male plug end 20 usually receives electricity for example by plugging into an electrical wall outlet.

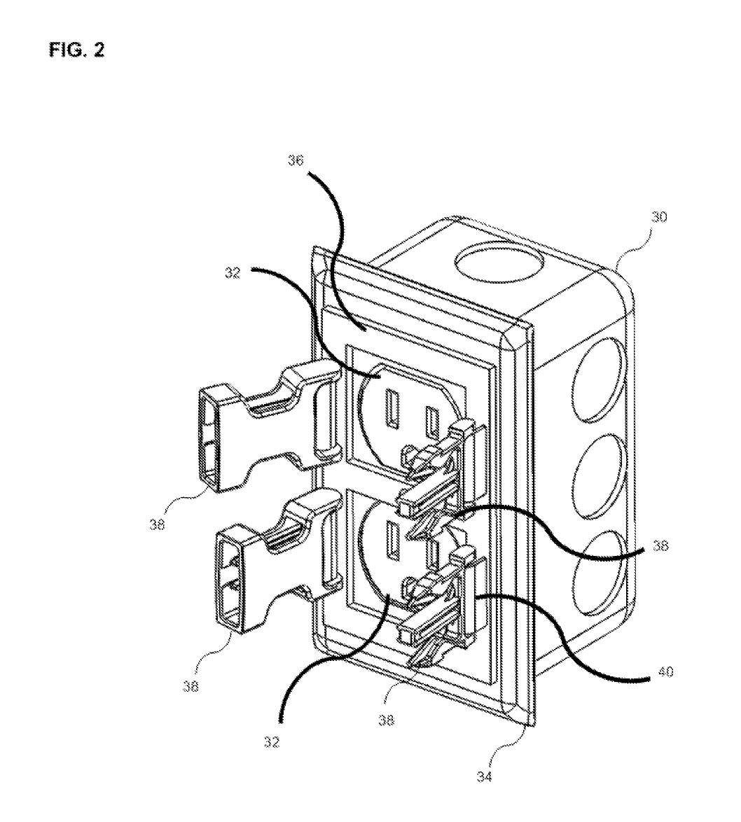

FIG. 2 depicts a drawing depicting a mode of the Cord, Cable and Hose (CCHF) Fastening System and Method, including tie connectors attached to a power, fluid, or material supply 38. In this figure the PFMS is an electrical outlet box 30 with two female electrical plugs 32, and an outlet cover 34. A PFMS frame 36 is attached to said outlet cover 34. Tie connector guides 40 hold tie connectors 38 and allow them to swivel and to fold in order to facilitate invention and become more compact during shipping or when not in use. Additional material may be used and installed between said tie connector guides 40 and said tie connectors 38 if spacing requirements will allow and if it will further facilitate said present invention.

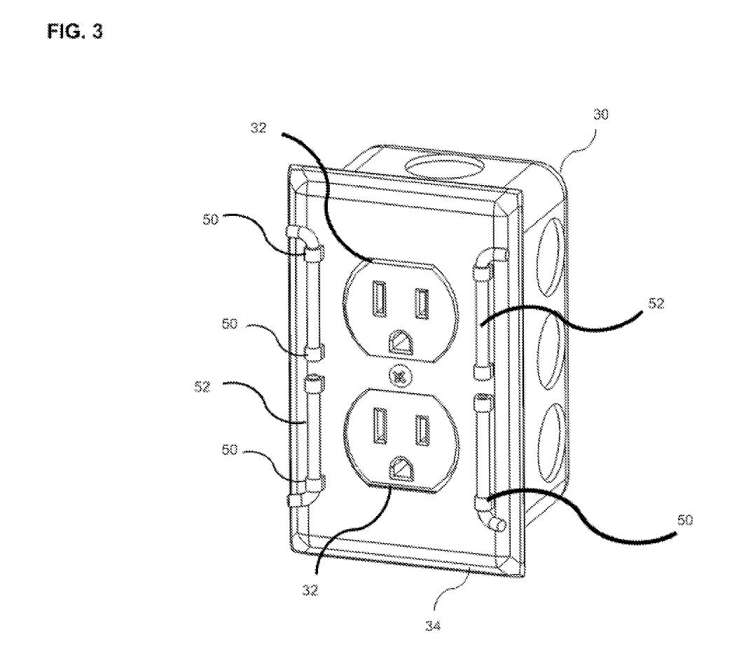

FIG. 3 depicts a drawing depicting a mode of the Cord, Cable and Hose (CCHF) Fastening System and Method, including collar tie stays attached to a power, fluid, or material supply 52. In this figure the PFMS is an electrical outlet box 30 with two female electrical plugs 32, and a PFMS cover 34 houses outlet cover guides 50 that hold collar tie stays 52. Said collar tie stays 52 may slide upward in order to allow incoming collar ties to fit behind them. Said collar tie stays 52 may be configured in various shapes and sizes. Said outlet cover guides may also allow a standardized object to serve as said collar tie stay 52, including but not limited to a nail.

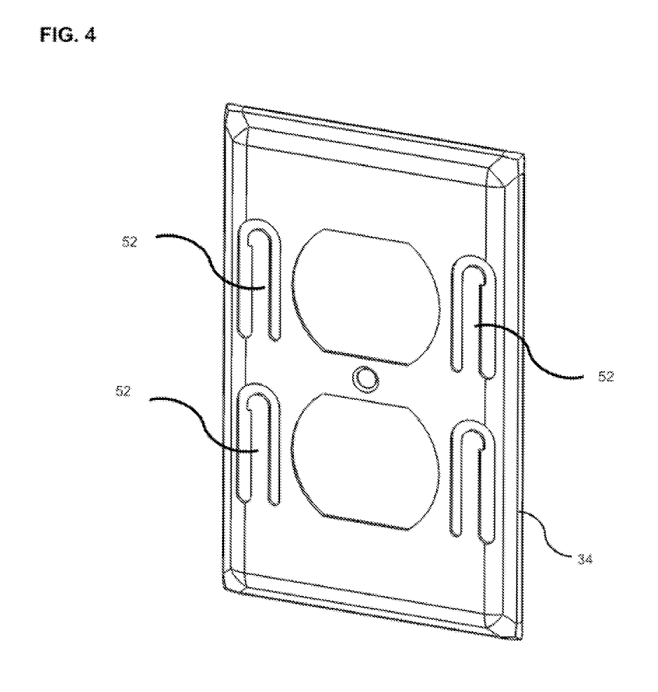

FIG. 4 depicts a drawing depicting a mode of the Cord, Cable and Hose (CCHF) Fastening System and Method, including a PFMS cover 34 with embedded collar stays 52. In this figure the PFMS cover 34 houses embedded collar tie stays 52. Said collar tie stays 52 are configured to allow incoming collar ties to weave in between said embedded collar tie stays 52 and said PFMS cover 34 in order to create friction and thereby hold said incoming collar ties in place in order to facilitate invention.

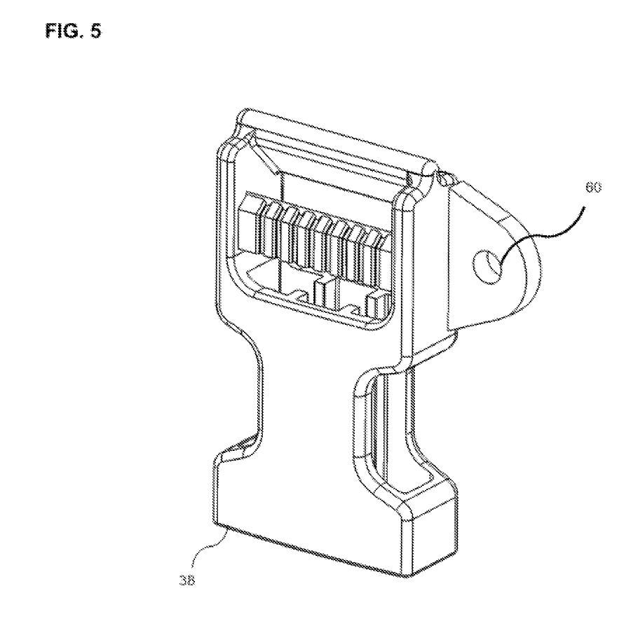

FIG. 5 depicts a drawing depicting a mode of the Cord, Cable and Hose (CCHF) Fastening System and Method, including a collar tie with a mounting hole. In this figure, a tie connector attached to or near a power, fluid, or material supply 38 is depicted with a mounting hole 60 in order to facilitate placement and mounting by means including but not limited to use of a screw, nail, rope, twine, cord, cable, a hook, or other mounting process.

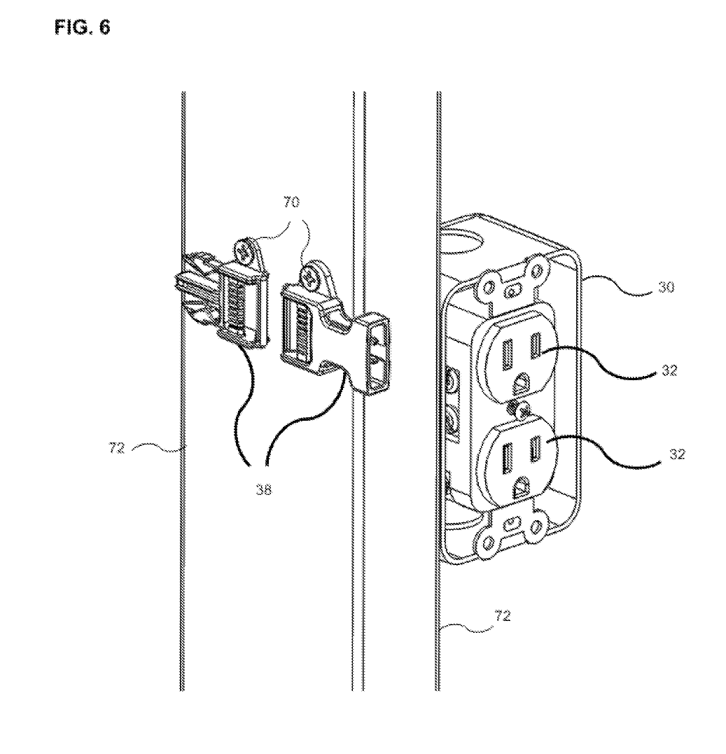

FIG. 6 depicts a drawing depicting a mode of the Cord, Cable and Hose (CCHF) Fastening System and Method, including a collar tie with a mounting hole and mounting means. In this figure the PFMS is an electrical outlet box 30 with two female electrical plugs 32, and tie connector 38 are displayed using a mounting means 70 that is a standard drywall screw that facilitates mounting to mounting source 72 that is depicted as a wooden wall stud. Numerous tie connectors 38 of various configurations including but not limited to singular, pairs, multiple or strip mounted, may be used and mounted as necessary in order to facilitate present invention.

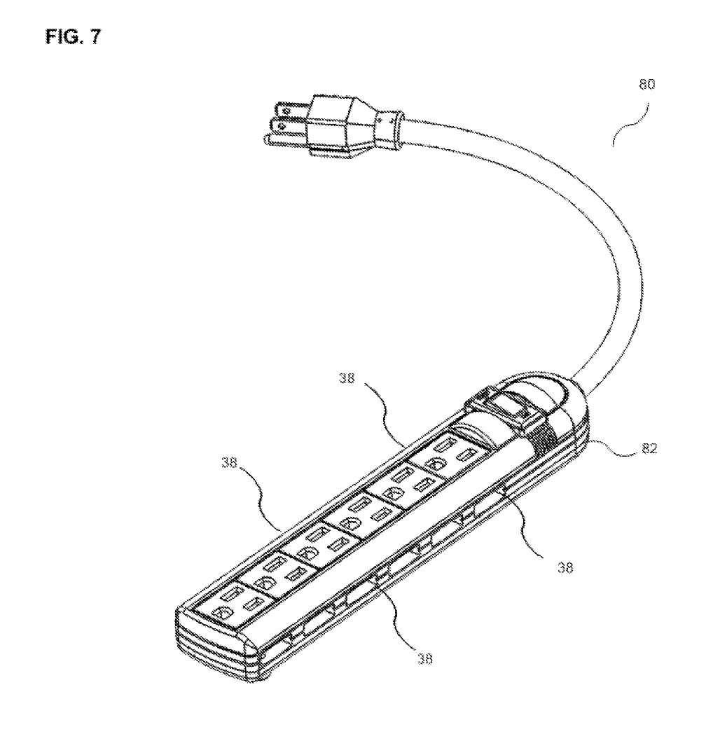

FIG. 7 depicts a drawing depicting a mode of the Cord, Cable and Hose (CCHF) Fastening System and Method, including tie connectors 38 attached to an electrical power strip 80, specifically embedded in the electrical power strip body 82. Said tie connectors 38 are depicted as an oval indentation that would accept an incoming tie connector that may have a form factor including but not limited to a male buckle. Said tie connectors 38 may be indented, embedded, flush, or may protrude, and may resemble many form factors including but not limited to male and female buckles. Collar tie stays may also be used to replace said tie connectors 38 or may be used in combination. Numerous tie connectors 38 of various configurations, including but not limited to singular, pairs, multiple or strip mounted, may be used and mounted as necessary in order to facilitate present invention. Any singular, pairs or strip mounting of said tie connectors 38 or said collar tie stays 52 may also be connected to said electrical power strip body 82 by several means including but not limited to screw-on, bolt-on, snap-on, use of hook and loop Velcro-style fastener, plastic cord, zip tie, and other mounting options.

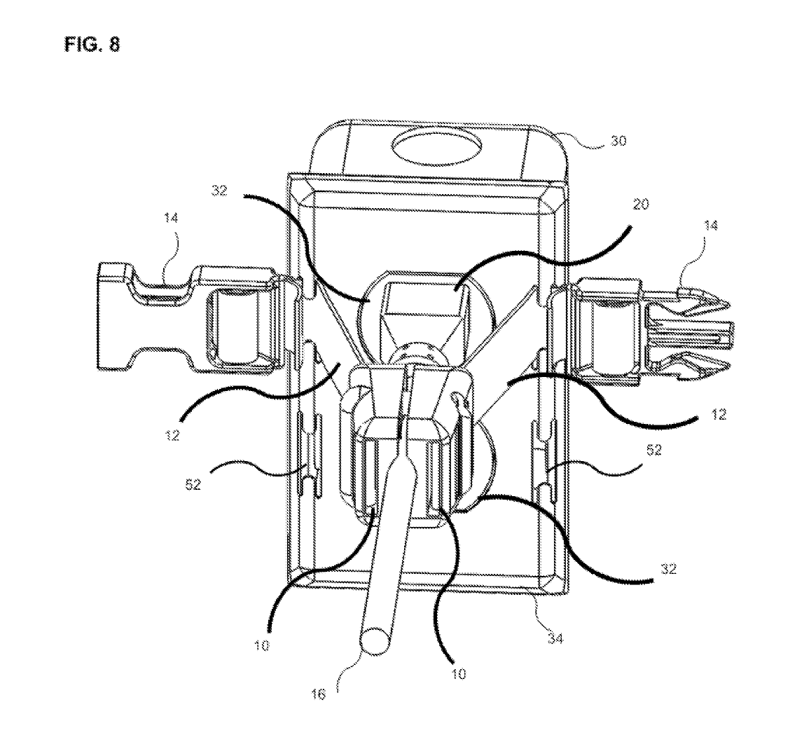

FIG. 8 depicts a drawing depicting a mode of the Cord, Cable and Hose (CCHF) Fastening System and Method, including collar tie stays attached to a power, fluid, or material supply 52. In this figure the PFMS is an electrical outlet box 30 with two female electrical plugs 32, and a PFMS cover 34 houses collar tie stays 52. Said collar tie stays 52 allow incoming collar ties 12 to fit behind them. Said collar tie stays 52 may be configured in various shapes and sizes. In this figure, a series of collars 10 attach to collar ties 12 which attach to tie connectors 14. Said collars 10 secure themselves to an electrical cord with a male end plug 16 designed to plug into female electrical plug 32.

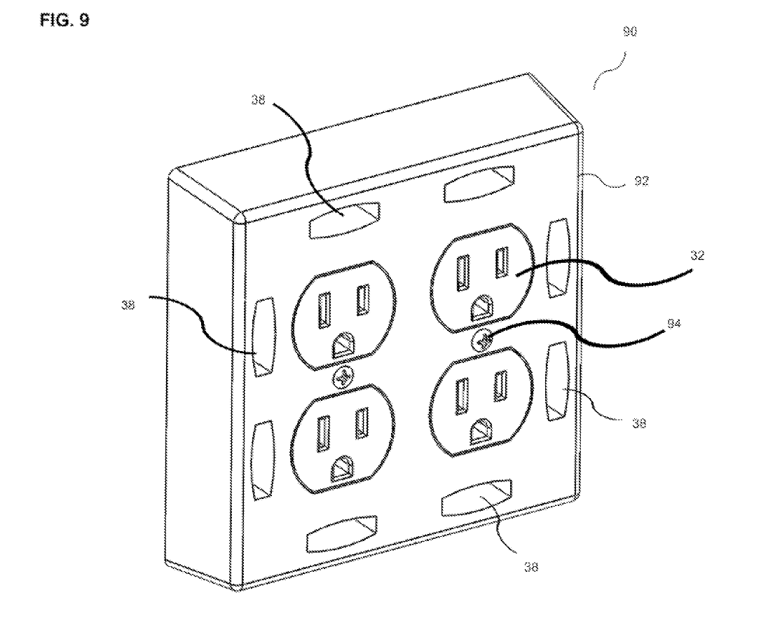

FIG. 9 depicts a drawing depicting a mode of the Cord, Cable and Hose (CCHF) Fastening System and Method, including tie connectors 38 attached to an electrical outlet multiplier or extension 90, specifically embedded in the electrical outlet multiplier or extension body 92. Said tie connectors 38 are depicted as an oval indentation that would accept an incoming tie connector that may have a form factor including but not limited to a male buckle. Said tie connectors 38 may be indented, embedded, flush, or may protrude, and may resemble many form factors including but not limited to male and female buckles. Collar tie stays may also be used to replace said tie connectors 38 or may be used in combination. Said tie connectors may be fit behind, aside, inside or near the electrical outlet multiplier or extension body 92. A screw 94 is depicted that typically holds said electrical outlet multiplier or extension body 92 to an electrical outlet box.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit.

1-20. (canceled)

21. A cord, cable or hose securing device, comprising:
a frame secured to a power, fluid and material supply (PFMS)
one or more tie connectors attached to said frame, to secure incoming tie connectors from existing cord, cable and hose fastening systems.

22. The device of claim 21, wherein the frame is made to be attachable and detachable to standard sized electrical and utility boxes and industrial power, fluid and material supply outlets.

23. The device of claim 21, wherein the tie connectors are made of buckles.

24. A cord, cable or hose securing device, comprising:
a frame secured to a power, fluid and material supply (PFMS)
one or more collar tie stays attached to said frame, to secure incoming collar ties from existing cord, cable and hose fastening systems.

25. The device of claim 24, wherein the frame is made to be attachable and detachable to standard sized electrical and utility boxes and industrial power, fluid and material supply outlets.

26. The device of claim 24, wherein the collar tie stays are made to capture and hold collar ties made of a material selected from the group of mesh-type and flexible polyurethane material.

27. A cord, cable or hose securing device, comprising:
a cover secured to a power, fluid and material supply (PFMS)
one or more tie connectors attached to said cover, to secure incoming tie connectors from existing cord, cable and hose fastening systems.

28. The device of claim 27, wherein the cover is made to be attachable and detachable to standard sized electrical and utility boxes and industrial power, fluid and material supply outlets.

29. The device of claim 27, wherein the tie connectors are made of buckles.

30. A cord, cable or hose securing device, comprising:
a cover secured to a power, fluid and material supply (PFMS)
one or more collar tie stays attached to said cover, to secure incoming collar ties from existing cord, cable and hose fastening systems.

31. The device of claim 30, wherein the cover is made to be attachable and detachable to standard sized electrical and utility boxes and industrial power, fluid and material supply outlets.

32. The device of claim 30, wherein the collar tie stays are made to capture and hold collar ties made of a material selected from the group of mesh-type and flexible polyurethane material.

33. A cord, cable or hose securing device, comprising:
a power strip-style power, fluid and material supply (PFMS) physical component
one or more tie connectors attached to said power strip-style power, fluid and material supply, to secure incoming tie connectors from existing cord, cable and hose fastening systems.

34. The device of claim 33, wherein the tie connectors are made of buckles.

35. The device of claim 33, wherein the power-strip style physical component contains electrical sockets to supply electrical power.

36. The device of claim 33, wherein the power-strip style physical component can consist of various from factors consisting of the group of rectangular, square, oval or rounded.

37. A cord, cable or hose securing device, comprising:
a power strip-style power, fluid and material supply (PFMS) physical component
one or more collar tie stays attached to said a power strip-style power, fluid and material supply (PFMS), to secure incoming collar ties from existing cord, cable and hose fastening systems.

38. The device of claim 37, wherein the collar tie stays are made to capture and hold collar ties made of a material selected from the group of mesh-type and flexible polyurethane material.

39. The device of claim 37, wherein the power-strip style physical component contains electrical sockets to supply electrical power.

40. The device of claim 37, wherein the power-strip style physical component can consist of various from factors consisting of the group of rectangular, square, oval or rounded.
